(19) United States
(12) Patent Application Publication
(10) Pub. No.: US 2025/0265776 A1
(43) Pub. Date: Aug. 21, 2025

(54) Interface for Controlling Immersive Environments

(71) Applicant: Meta Platforms Technologies, LLC, Menlo Park, CA (US)

(72) Inventors: Matthew Joseph ESQUIVEL, Redmond, WA (US); Baran USLUEL, Seattle, WA (US)

(21) Appl. No.: 19/032,889

(22) Filed: Jan. 21, 2025

Related U.S. Application Data
(60) Provisional application No. 63/556,153, filed on Feb. 21, 2024.

(51) Int. Cl. G06T 17/00; G06T 13/40

(52) U.S. Cl. CPC G06T 17/00; G06T 13/40

(57) ABSTRACT

Aspects of the present disclosure are directed to controlling an immersive environment via an application programming interface (API). Some applications executing via artificial reality systems provide immersive content for display to the user. However, other types of artificial reality applications provide lighter weight content (e.g., two-dimensional content, three-dimensional content that is not immersive, etc.), such as a web browser, video player, social media application, communication application, and many others. These executing applications that provide content for portions of the artificial reality system's display often have limited control over the immersive elements of the artificial reality system, such as the immersive environment in which a two-dimensional or three-dimensional virtual object is displayed. Implementations of an immersive controller provide these applications an API for controlling these elements of the immersive environment via an API call.

### CROSS-REFERENCE TO RELATED APPLICATIONS

This application claims priority to U.S. Patent Provisional Application No. 63/556,153, titled “Interface for Controlling Immersive Environments,” filed on Feb. 21, 2024, which is herein incorporated by reference in its entirety.

### TECHNICAL FIELD

The present disclosure is directed to controlling an immersive environment via an application programming interface.

### BACKGROUND

Artificial reality systems have grown in popularity and this trend is expected to accelerate. Immersive artificial reality environments can provide unique experiences and support virtual social interactions among users. Artificial reality systems execute a diverse set of applications. For example, some executing applications provide a fully immersive environment, while other executing applications provide two-dimensional content or a limited variety of three-dimensional content. Supporting this diverse set of applications increases the utility of artificial reality systems and improves the user experience under a variety of usage scenarios.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a conceptual diagram of an interface call from an executing application to a display controller.

FIGS. 6A and 6B are conceptual diagrams that illustrate dynamically changing an immersive environment via an interface call.

FIGS. 7A and 7B are conceptual diagrams that illustrate dynamically adding scene components to an immersive environment via an interface call.

FIG. 8 is a flow diagram illustrating a process used in some implementations of the present technology for controlling an immersive environment via an application programming interface.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to controlling an immersive environment via an application programming interface (API). Some applications executing via artificial reality systems provide immersive content for display to the user, such as virtual reality applications, immersive gaming applications, and the like. However, other types of artificial reality applications provide lighter weight content (e.g., two-dimensional content, three-dimensional content that is not immersive, etc.), such as a web browser, video player, social media application, communication application (e.g., video calling, messaging, etc.), productivity application, and many others. These executing applications that provide content for portions of the artificial reality system's display often have limited control over the immersive elements of the artificial reality system, such as the artificial reality environment in which a two-dimensional or three-dimensional virtual object is displayed. Implementations of an immersive controller provide these applications a mechanism for controlling these elements of the immersive environment. For example, an executing web browser may display a website via a two-dimensional panel, and the website may trigger an interface call to the immersive controller that controls the immersive environment in which the web browser is displayed.

In some implementations, the artificial reality application that provides non-immersive content can be a web browser, a progressive web application, or any other suitable application. In an example, the artificial reality application may be given privileges to display content into a portion of the artificial reality system's display, such as a two-dimensional panel and/or three-dimensional volume. Accordingly, the executing application may dynamically provide content for this two-dimensional panel or three-dimensional volume, such as dynamically displaying a website and website-related functionality via the panel/volume. However, the application may lack privileges for other elements of the artificial reality system's display, such as the immersive environment within which the two-dimensional panel or three-dimensional volume is displayed. Implementations of the immersive controller provide an interface that permits the artificial reality application control over the immersive environment even though the application lacks this privilege. For example, the immersive controller can communicate with and/or be part of a system shell for the artificial reality system, and the system shell can dynamically display immersive content in response to an interface call to the immersive controller. In other words, the artificial reality system shell may have the privileges associated with displaying immersive content, and the interface call to the immersive controller can utilize the system shell and its privileges to alter the immersive environment.

The interface call can be an application programming interface (API) call that includes indicators for immersive content resources, such as images, videos, three-dimensional models, scene models (e.g., Graphics Library Transmission Format (gITF) files), and the like. In some implementations, the API call can include an indicator for the immersive content and define which portion of the immersive environment in which to display the immersive content (e.g., skybox, foreground, background, three-dimensional volume definition, etc.). In response, the immersive controller can load the immersive content resources and display, via the system shell, the loaded immersive content. In some implementations, the interface for the immersive controller can be a web API, such as a JavaScript web API.

When a web browser is executing at the artificial reality system, a website loaded (or being loaded) by the web browser can issue an interface call to the web API via the web browser to alter the immersive environment in which the browser/website is displayed. For example, when navigating to a certain webpage of the website, or in response to a user interaction with the website (e.g., button press, mouse over, navigation to a certain section, etc.) the website can issue the web API call to alter the immersive environment, thus achieving an immersive feel for the website. In another example, a video player may issue an API call at a certain timestamp in a movie or when a certain video is played to enhance the immersive feel of the content. In another example, an audio player may issue an API call in response to playing a particular song to add an immersive element to the user's listening experience.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional XR systems support fully immersive XR applications or XR applications with limited display privileges. However, these rigid structures restrict the XR applications with limited privileges from utilizing the immersive environment elements of the XR system. For example, a conventional XR browser may have limited rights to alter the XR environment in which the browser is displayed, but this XR browser in conventional systems is not able to permit a loaded website to alter the XR environment. Similarly, other XR applications that lack the privileges to alter the immersive environment elements of a XR display (e.g., skybox, foreground, background, etc.) may underutilize the immersive capabilities of XR systems due to these conventional restraints.

The disclosed immersive controller provides a pathway for XR applications with limited privileges to control the XR environment in which the XR applications execute or operate. For example, the immersive controller exposes an application programming interface to these XR applications that permits these applications greater control over the immersive components of the XR system display. Implementations of the immersive controller also support website triggered XR environment display changes via the exposed API, with strict parameters and uses for the supplied controls and content, thereby ensuring system security and data privacy. Thus, the disclosed system enhances XR system functionality and flexibility, while maintaining system security and data privacy between applications.

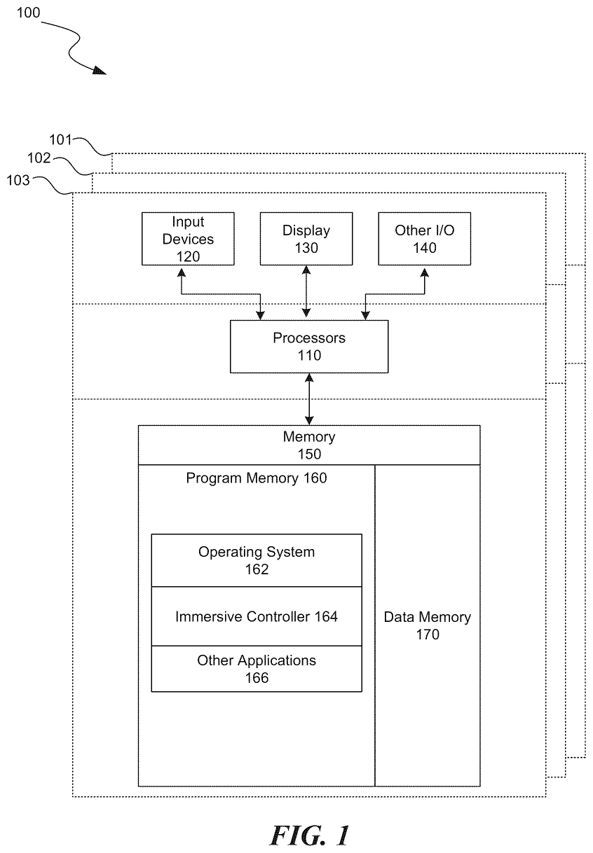

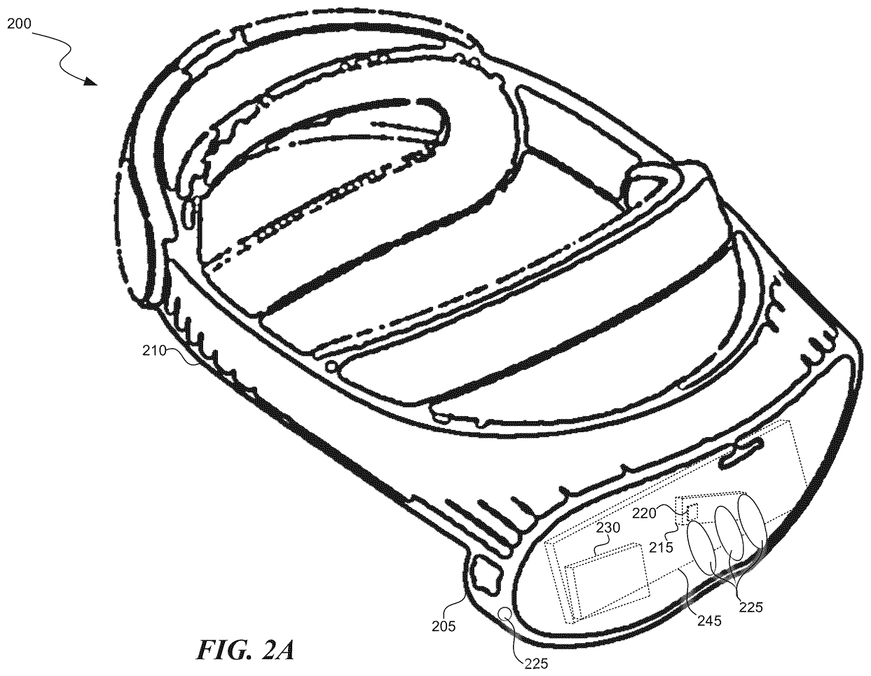

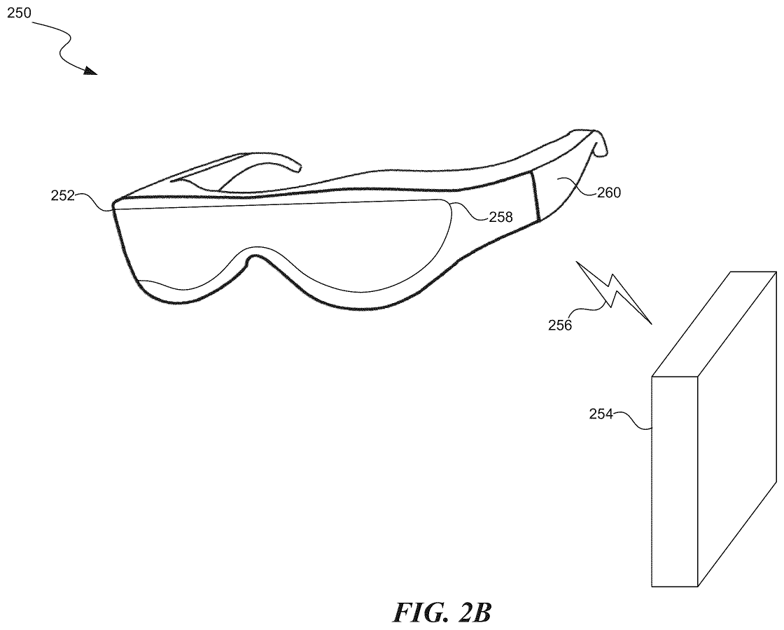

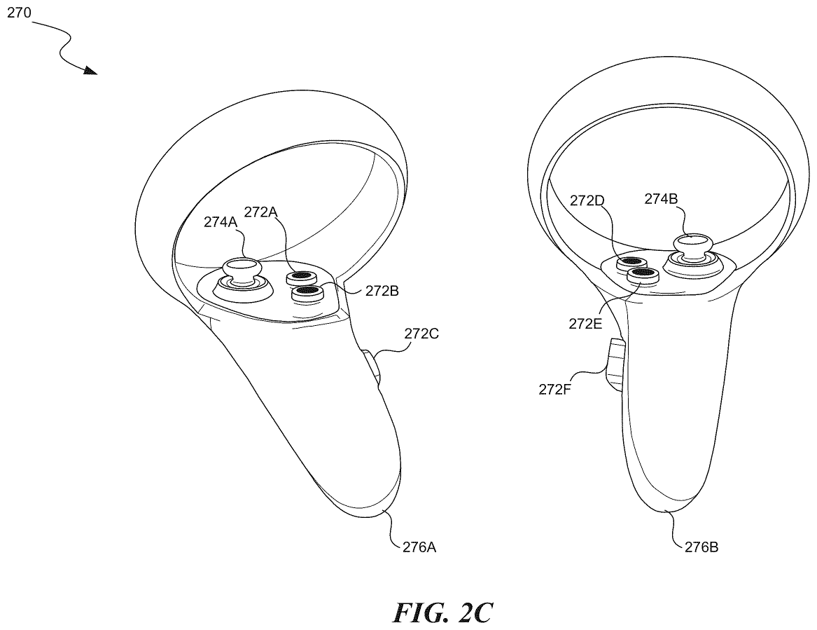

Several implementations are discussed below in more detail in reference to the figures. FIG. 1 is a block diagram illustrating an overview of devices on which some implementations of the disclosed technology can operate. The devices can comprise hardware components of a computing system 100 that control an immersive environment via an application programming interface (API). In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, immersive controller 164, and other application programs 166. Memory 150 can also include data memory 170 that can include, e.g., immersive content (e.g., images, videos, three-dimensional models, etc.), XR application data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

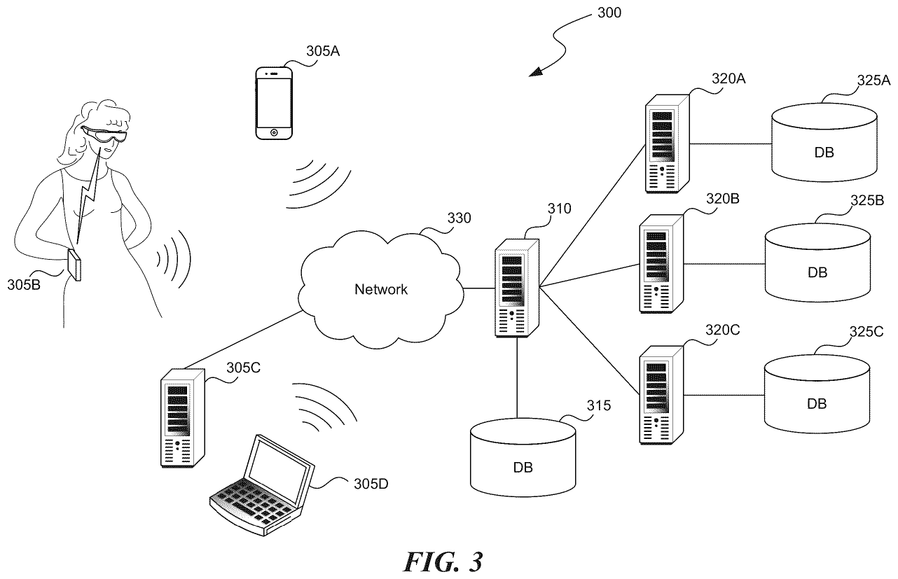

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

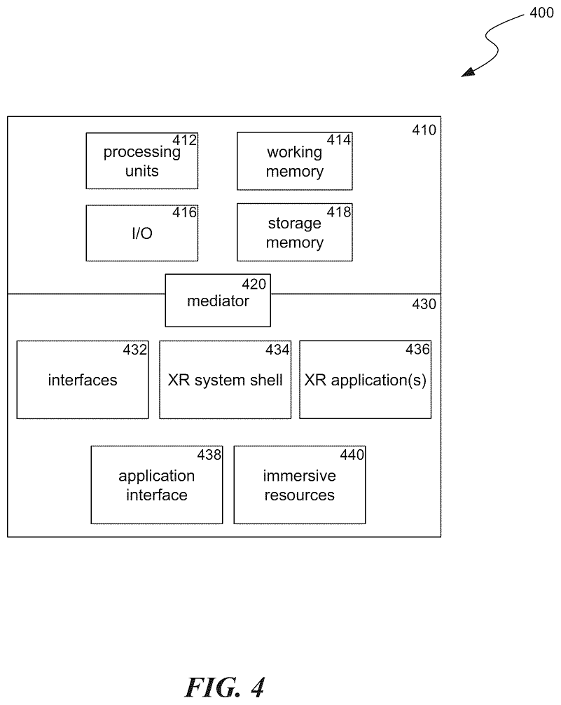

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for controlling an immersive environment via an application programming interface. Specialized components 430 can include XR system shell 434, XR application(s) 436, application interface 438, immersive resources 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

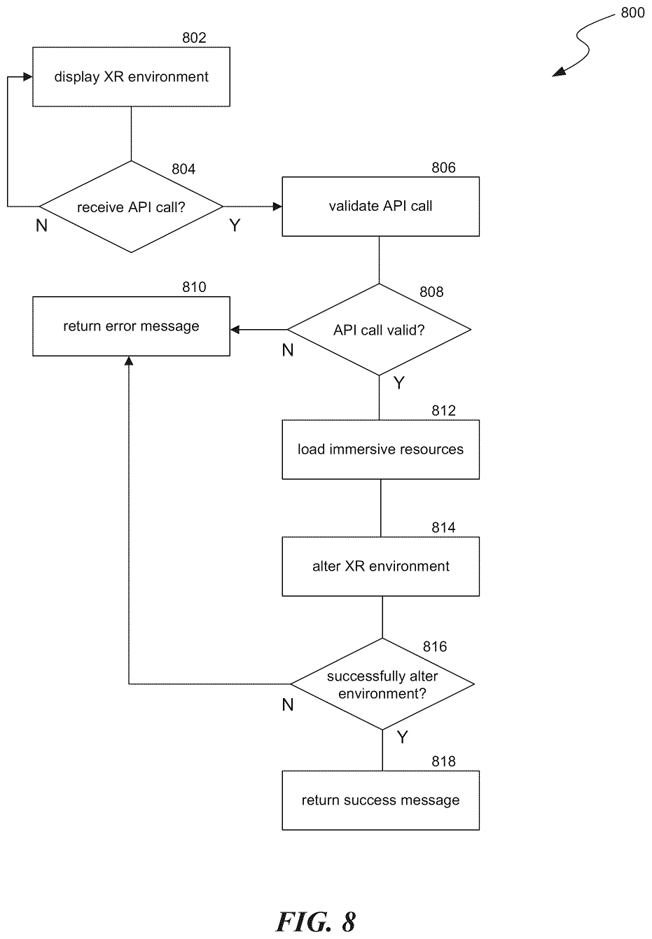

XR system shell 434 can manage the software components of a XR system, such as system display components, software functionality for system display components, and interactions with launched applications. For example, XR system shell 434 can be a shell environment in which applications are executed, such as shell applications or applications remote from the shell (e.g., XR application(s) 436). Implementations of XR system shell 434 can interact with the applications executing at the XR system to manage visual displays for the applications, such as two-dimensional virtual object displays (e.g., panels) and/or three-dimensional virtual objects. XR system shell 434 can also manage immersive display components for the XR system, such as an immersive environment displayed to the user while one or more of XR application(s) 436 are executed. In some implementations, XR system shell 434 can comprise several units of executing software in combination. For example, XR system shell 434 can include and/or communicate with application interface 438 to provide an API for XR application(s) 436 to control an XR environment displayed by the XR system. Additional details on XR system shell 434 are provided below in relation to blocks 802-818 of FIG. 8.

XR application(s) 436 can include applications that execute, at least in part, at the XR system and provide content for display to a user. For example, XR application(s) 436 can provide two-dimensional content and/or three-dimensional content (e.g., non-immersive three-dimensional content) for display in one or more virtual objects positioned in an XR environment managed by XR system shell 434. Examples of XR application(s) 436 include web browsers, music players, video players, social media applications, messaging or other communication applications, third-party applications, streaming/casting applications, a content library application, or any other suitable application. Additional details on XR application(s) 436 are provided below in relation to blocks 802, 804, 810, and 818 of FIG. 8.

Application interface 438 is an interface between executing applications (e.g., XR application(s) 436) and the XR system component(s) that manage the XR system's immersive display (e.g., XR system shell 434). For example, executing XR application(s) 436 may provide two-dimensional content and/or three-dimensional content for display via one or more virtual objects, however the executing XR application(s) may not possess privileges to provide immersive content for display via the XR system. Application interface 438 is a pathway that supports control by XR application(s) 436 of the immersive display component of the XR system. For example, one or more XR application(s) 436 can issue a call (e.g., API call) to application interface 438 that comprises one or more indicators of immersive resources 440. Application interface 438 can be part of or in communication with XR system shell 434, which can implement changes to the immersive display (e.g., three-dimensional XR environment, skybox, three-dimensional scene elements, etc.) in response to the call. Additional details on application interface 438 are provided below in relation to blocks 804, 806, 808, and 810 of FIG. 8.

Immersive resources 440 are any resources for display in an immersive environment. For example, immersive resources 440 include images, video, three-dimensional models, scene graphs and/or data structures, .gITF files, or any other suitable immersive resource. In some implementations, an API call to application interface 438 can comprise one or more indicators to one or more immersive resources 440, such as a uniform resource indicator (URI), uniform resource locator (URL), or any other suitable indicator. Additional details on immersive resources 440 are provided below in relation to 804, 806, 808, and 812, and 814 of FIG. 8.

Some executing applications comprise limited privileges with respect to where they can display content via an XR system display. For example, the display environment for an XR system shell can be an XR environment (e.g., three-dimensional immersive environment). An XR application executing at the XR system can provide content that is displayed via an element within this displayed shell environment, such as a two-dimensional panel or three-dimensional volume. For example, the executing XR application can comprise privileges that permit the application to provide content for the panel/volume. Examples of this type of executing XR application include web browsers, music players, video players, social media applications, messaging or other communication applications, third-party applications, streaming/casting applications, a content library application, or any other suitable application. In some implementations, an XR application of this type can issue an interface call to an exposed API that grants the XR application control over the immersive display environment even though the XR application has limited privileges. For example, the XR system shell can alter the immersive environment responsive to the API call.

In some implementations, the XR system can concurrently execute two, three, or more XR applications and the three-dimensional environment can concurrently display two, three, or more corresponding virtual objects that display contents for the executing XR applications. The concurrently displayed virtual objects can be side-by-side panel displays in some implementations. In this example, the XR application that is in focus (e.g., the XR application that corresponds to the virtual object that the user is interacting with or last interacted with) may be permitted to issue API calls to control the immersive display environment. In some implementations, one of the concurrently executing XR applications can be assigned priority to issue API calls via any other suitable manner.

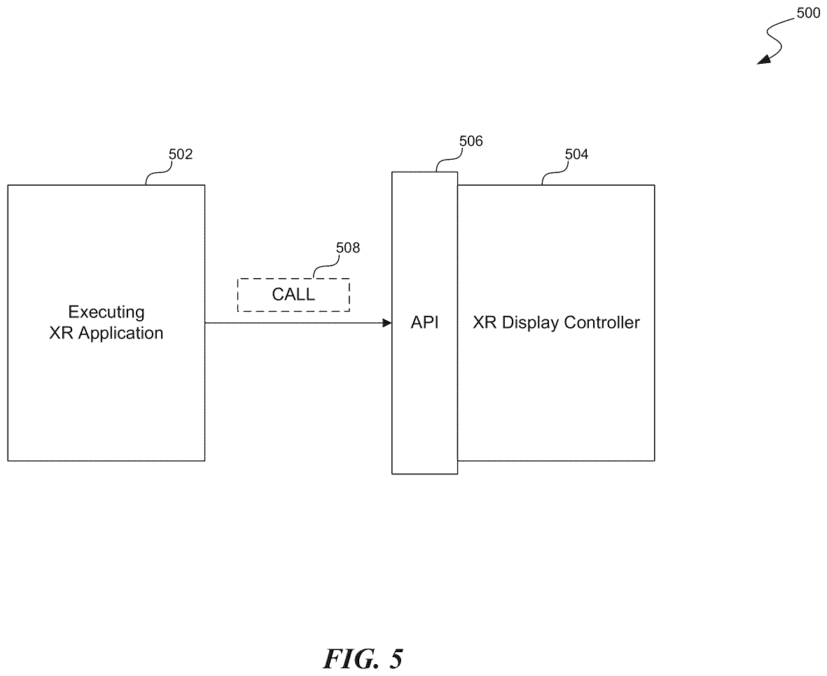

FIG. 5 is a conceptual diagram of an interface call from an executing application to a display controller. Diagram 500 includes executing XR application 502, XR display controller 504, API 506, and API call 508. In the illustrated example, executing XR application 502 may comprise privileges to provide content for display at a virtual object within a displayed XR environment, however may lack privileges to alter the XR environment itself. API 506 provides a pathway for executing XR application 502 to control the XR environment via XR display controller 504.

XR display controller 504 can comprise an XR system shell or any other suitable software component with privileges to alter the display of an XR environment. API 506 can be exposed to executing XR application 502, where API call 508 can comprise resource indicators for altering the displayed XR environment. For example, API call 508 can be one of a predefined type of API calls that correspond to particular XR environment functionality, such as set background, load scene components, etc. In addition, API call 508 can include indicators for immersive resources, such as URIs, URLs, or any other suitable indicators. These immersive resource indicators can correspond to images, videos, three-dimensional models, XR scenes, gITF files, and the like.

API 506 can be a web API, such as a JavaScript API, or any other suitable API. For example, executing XR application 502 can be a web browser or progressive web application (PWA) that implements calls to API 506. In some implementations, a website loaded by (or being loaded by) executing XR application 502 triggers API call 508 to API 506. In some implementations, executing XR application 502 is a video or audio player, and API call 508 is triggered at a certain timestamp during playback of the video or audio.

The following is an example of the structure of API 506:
window.setEnvironment
   Can be used to detect if the API is supported or not.
window.setEnvironment (URI environment)
   In some examples, a “null” for environment can be used revert to a default environment.
   “environment” can be a content item, or a URI or URL indicating the location of the environment. If this location remote (on a webserver) the resource can be downloaded and cached similar to URIs to images.
   The content item can be, or the URI/URL can point to, an image (jpg/jpeg/png) and/or a .gltf file.
      If an image, the image can be projected on a sphere or cube around the user (a static skybox).
   The API can return a JavaScript promise which “resolves” when the environment is set and rejected if the request is not able to be granted.
   In some implementations a permission prompt is shown to the user prior to altering the environment. If the user approves the request the environment can be changed and the promise can be resolved.
   In some implementations the operating system is prompted prior to altering the environment. The operating system can approve or reject the request.
window.getEnvironment( )
   Returns the current environment (e.g., as a URI) or null if the environment is the default environment.
   In some implementations, the current environment is returned to an executing XR application when that application has set the environment.
      In this example, an executing XR application does not have visibility into environments set by other executing XR applications.
window.environmentChanged
   Event fired when the environment successfully changed.

In some implementations, one or more of the immersive resources indicated by the API call 508 can be validated. Validating immersive resources can include verifying that the immersive resources are permitted file types (e.g., permitted image file type, permitted video file type, permitted three-dimensional model file type, gITF, etc.), verifying that a size of the resource does not exceed a size threshold, verifying that the indicator(s) point to a location that is part of an allow list and/or verifying that the indicator(s) do not point to a location that is part of a block list (e.g., known malicious URLs, etc.), and the like. For example, XR display controller 504 and/or an interface manager (e.g., application interface 438 of FIG. 4) can perform one or more of these validation checks prior to performing the functionality corresponding to API call 508 (e.g., altering the immersive components of the XR system display). When one or more of the validation checks fail, API call 508 can be rejected. When the validation check(s) are successful, XR display controller 504 can perform the change(s) to the XR system display that correspond to API call 508.

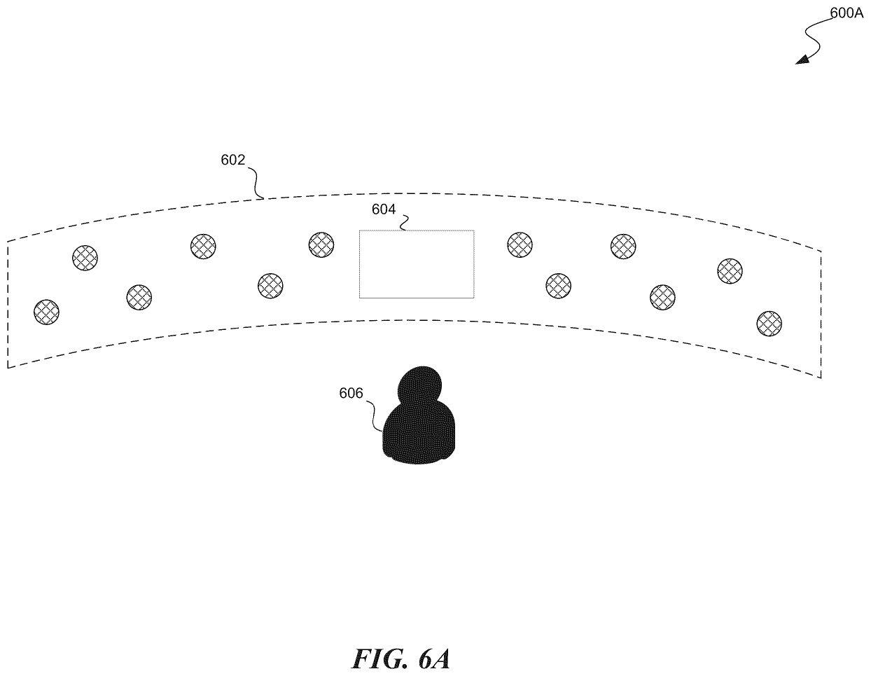

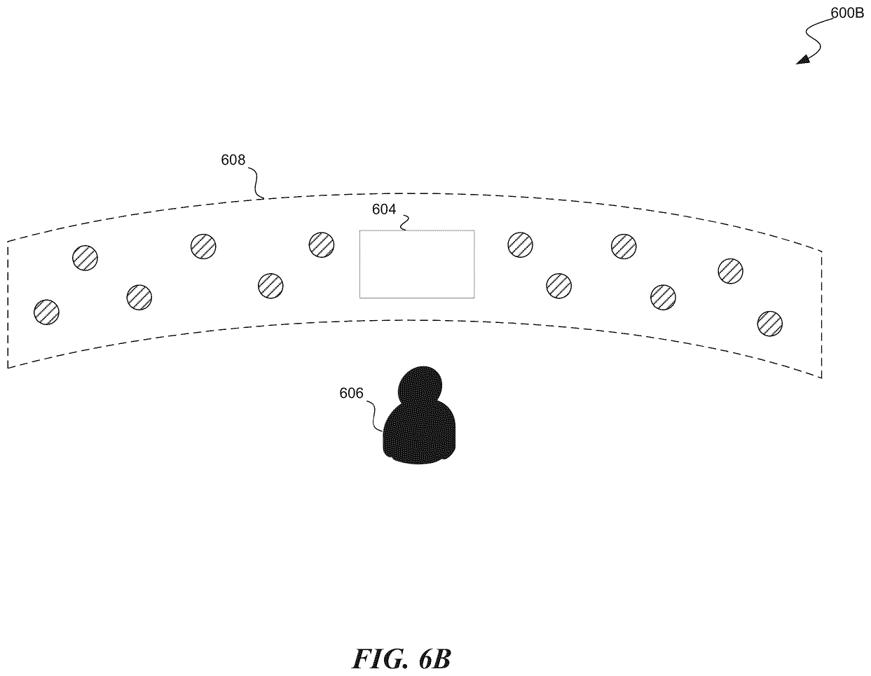

FIGS. 6A and 6B are conceptual diagrams that illustrate dynamically changing an immersive environment via an interface call. Diagram 600A includes immersive environment 602, virtual object 604, and user 606, and diagram 600B includes immersive environment 608, virtual object 604, and user 606. For example, in response to an API call from an executing XR application, an XR display controller can dynamically change from displaying immersive environment 602 to displaying immersive environment 608. For example, immersive environment 608 can be displayed using immersive resources loaded in response to the API call, such as images, video, XR scene components, three-dimensional models, and the like.

In some implementations, virtual object 604 can comprise a virtual object assigned to the executing XR application (e.g., a two-dimensional panel), such that content from the executing XR application (e.g., loaded websites, a content library, music player visual information, video player visual information, social media visual information, etc.) is displayed via virtual object 604. In this example, virtual object 604 is displayed within immersive environment 608, which is changed in response to the API call from the executing XR application. In other words, the API call supports XR environment control by the executing XR application of the XR environment in which its virtual object is displayed.

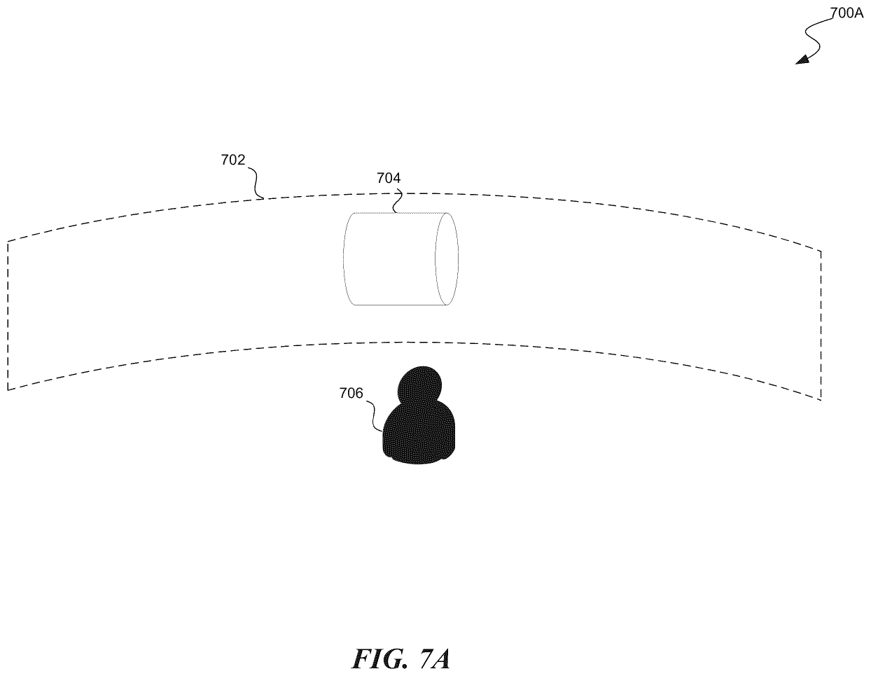

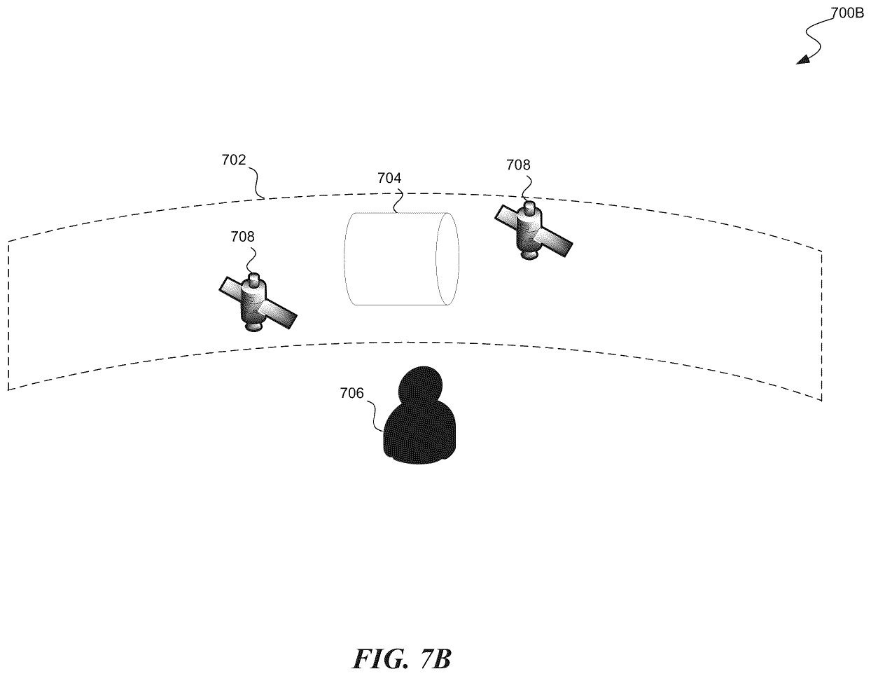

FIGS. 7A and 7B are conceptual diagrams that illustrate dynamically adding scene components to an immersive environment via an interface call. Diagram 700A includes immersive environment 702, virtual object 704, and user 706, and diagram 700B includes immersive environment 702, virtual object 704, user 706, and scene components 708. For example, in response to an API call from an executing XR application, an XR display controller can dynamically add scene components 708 to immersive environment 702. For example, scene components 708 can be displayed using immersive resources loaded in response to the API call, such as XR scene components, three-dimensional models, a .gITF file, and the like.

In some implementations, virtual object 704 can comprise a three-dimensional virtual object assigned to the executing XR application, such that content from the executing XR application is displayed via virtual object 604. In this example, virtual object 604 is displayed within immersive environment 702, and scene components 708 is added in response to the API call. In other words, the API call supports XR environment control by the executing XR application of the XR environment in which its virtual object is displayed.

In some implementations, the immersive resources indicated in an API call can be indicators that point to a library of immersive resources. For example, a predefined library of images, videos, XR scenes, .gltf files, etc. can be stored, and the API call can utilize these immersive resources to alter the display immersive environment. The library can be stored at the XR system, remote from the XR system, or both.

Those skilled in the art will appreciate that the components illustrated in FIGS. 1-5, 6A, 6B, 7A, and 7B described above, and in the flow diagram discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 8 is a flow diagram illustrating a process used in some implementations of the present technology for controlling an immersive environment via an application programming interface (API). In some implementations, process 800 can be triggered in response to an API call for an executing application. Process 800 can be performed at an XR system, a cloud system, an edge system, a companion device, at any other suitable computing device, or any combination thereof.

At block 802, process 800 can display an XR environment to a user. For example, an XR system can display an immersive XR environment to a user. In some implementations, the XR environment is managed by a system shell and one or more executing XR applications provide content for a virtual object displayed within the XR environment. For example, the system shell may have privileges to display content via the XR environment and the executing XR application may have privileges to provide content for display via the virtual object. Examples of executing XR applications include web browsers, music players, video players, social media applications, messaging or other communication applications, third-party applications, streaming/casting applications, a content library application, or any other suitable application.

At block 804, process 800 determines whether an API call is received. For example, the system shell can expose an API (e.g., via an immersive controller) to executing XR applications, and an executing XR application can issue an API call to the exposed API. The API call can comprise one or more indicators to immersive resources (e.g., URI(s), URL(s), etc.). For example, the one or more immersive resources can comprise an image, one or more three-dimensional models, a video, an animated three-dimensional object, or any combination thereof. In some implementations, the API can comprise a web API, such as a JavaScript API.

In some implementations, an executing XR application can comprise a web browser, and an API call can be triggered by a webpage loaded at the web browser. In some implementations, an executing XR application can comprise an audio or video player that is playing media content, and an API call can be triggered based on a timestamp of the playing media content. When an API call is received, process 800 progresses to block 806. When an API call is not received, process 800 returns to block 802, where the XR environment is displayed to the user until an API call is received at block 804.

At block 806, process 800 can validate the API call. For example, the API call can be validated as one of a predefined type of API call (e.g., set XR environment background, set XR environment scene components, etc.). In some implementations, one or more of the immersive resources indicated by the API call can be validated. Validating immersive resources can include verifying that the immersive resources are permitted file types (e.g., permitted image file type, permitted video file type, permitted three-dimensional model file type, gITF, etc.), verifying that a size of the resource does not exceed a size threshold, verifying that the indicator(s) point to a location that is part of an allow list and/or verifying that the indicator(s) do not point to a location that is part of a block list (e.g., known malicious URLs, etc.), and the like.

At block 808, process 800 determines whether the API call is valid. For example, when the validation at block 806 is positive, the API call be valid, and when the validation at block 806 is negative the API call can be invalid. When the API call validates, process 800 can progress to block 812. When the API call does not validate, process 800 can progress to block 810.

At block 810, process 800 can return an error message to the executing XR application. For example, the error message can indicate that the API call did not validate. In some implementations, the error message can provide a reason that the API call was invalid (e.g., immersive resource too large, improper file type, immersive resource at a blocked location, immersive resource not located at a permitted location, etc.).

At block 812, process 800 can load the immersive resources indicated in the API call. For example, the immersive resources can be image(s), video(s), three-dimensional model(s), immersive scene(s) (e.g., .gITF files), and the like. In some implementations, one or more of the immersive resources may be cached at the XR system, and loading an immersive resource can include updating the cached version.

At block 814, process 800 can alter the displayed XR environment. For example, the loaded immersive resources can be used to alter the XR environment. In some implementations, a loaded image or video (e.g., looped video) can be projected onto a three-dimensional shape (e.g., sphere, etc.) and the background of the XR environment can be altered using the projected image/video. In some implementations, a scene and/or three-dimensional model can be loaded and displayed via the XR environment. For example, a scene with multiple scene components can be displayed, such as three-dimensional virtual objects that can include animation. Any other aspect of the XR environment can be altered via the loaded immersive resource(s). In some implementations, the XR environment is altered by the system shell in response to the validated API call from the executing XR application.

In some implementations, the limited permissions of the executing XR application(s) permit control of non-immersive content displayed via a virtual object and do not permit control of immersive content for display via the XR system, and the API exposed by software at the XR system supports display of the immersive content via the API call(s) from the XR application(s). For example, the virtual object(s) that the XR application(s) are permitted to control (e.g., provide content for) can comprise two-dimensional virtual object(s) and the non-immersive content (provided by the XR application(s)) can comprise two-dimensional content. The immersive content (provided via the API call(s)) can comprise an immersive XR environment, and the virtual object and non-immersive content can be displayed within the immersive XR environment.

At block 816, process 800 can determine whether the XR environment was successfully altered. For example, the system shell may load and display the immersive resource(s) indicated in the API call. The XR environment is successfully altered when the loading and displaying of the immersive resource(s) is performed successfully (e.g., without error). The XR environment is not successfully altered when loading and/or displaying experiences an error. When the XR environment is successfully altered, process 800 progresses to block 818. When the XR environment is not successfully altered, process 800 progresses to block 810, where an error message is returned to the executing XR application.

At block 818, process 800 can return a success message to the executing XR application. The success message indicates to the XR application that the XR environment in which the executing XR application's virtual object is displayed has been successfully altered. In some implementations, the XR application can alter its executing based on whether or not the environment is successfully altered. For example, in response to a failed attempt to alter the XR environment: an audio player can pause playback of audio, a video player can pause playback of video, a web browser can navigate to a predefined webpage and/or trigger dynamic functionality via software logic that alters the flow of navigation of a website in response to the failed alteration of the XR environment, and the like. In response to a successful attempt to alter the XR environment: the audio player can continue playback of audio, the video player can continue playback of video, the web browser can navigate to another predefined webpage and/or trigger dynamic functionality via software logic that progresses the flow of navigation of a website in response to the successful alteration of the XR environment, and the like.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for controlling an immersive environment via an application programming interface, the method comprising:
executing, at an artificial reality (XR) system, an XR application assigned limited permissions to provide non-immersive content for a virtual object;
receiving, from the executing XR application, an application programming interface (API) call that comprises one or more indicators for one or more immersive resources;
loading, in response to the API call, the one or more immersive resources; and
displaying, by a system shell of the XR system and in response to the loading: a) non-immersive content, within the virtual object, provided by the executing XR application, and b) immersive content using the one or more loaded immersive resources.

2. The method of claim 1, wherein,
the limited permissions of the executing XR application permit control of the non-immersive content displayed via the virtual object and do not permit control of the immersive content for display via the XR system, and
an API exposed by software at the XR system supports display of the immersive content via the API call from the XR application.

3. The method of claim 2, wherein,
the virtual object comprises a two-dimensional virtual object and the non-immersive content comprises two-dimensional content,
the immersive content comprises an immersive XR environment, and
the virtual object and non-immersive content are displayed within the immersive XR environment.

4. The method of claim 1, wherein the one or more immersive resources comprise an image, one or more three-dimensional models, a video, an animated three-dimensional object, or any combination thereof.

5. The method of claim 1, wherein the immersive content comprises an image or video projected onto a three-dimensional shape.

6. The method of claim 1, wherein the executing XR application comprises a web browser, and the API call is triggered by a webpage loaded at the web browser.

7. The method of claim 1, wherein the executing XR application comprises an audio or video player that is playing media content, and the API call is triggered based on a timestamp of the playing media content.

8. The method of claim 1, further comprising:
validating, prior to displaying the immersive content, the one or more immersive resources indicated by the API call.

9. An artificial reality (XR) system for controlling an immersive environment via an application programming interface, the XR system comprising:
one or more processors; and
one or more memories storing instructions that, when executed by the one or more processors, cause the XR system to:
execute an XR application assigned limited permissions to provide non-immersive content for a virtual object;
receive, from the executing XR application, an application programming interface (API) call that comprises one or more indicators for one or more immersive resources;
load, in response to the API call, the one or more immersive resources; and
display, by a system shell of the XR system and in response to the loading:
a) non-immersive content, within the virtual object, provided by the XR application, and b) immersive content using the one or more loaded immersive resources.

10. The XR system of claim 9, wherein,
the limited permissions of the executing XR application permit control of the non-immersive content displayed via the virtual object and do not permit control of the immersive content for display via the XR system, and
an API exposed by software at the XR system supports display of the immersive content via the API call from the XR application.

11. The XR system of claim 10, wherein,
the virtual object comprises a two-dimensional virtual object and the non-immersive content comprises two-dimensional content,
the immersive content comprises an immersive XR environment, and
the virtual object and non-immersive content are displayed within the immersive XR environment.

12. The XR system of claim 9, wherein the one or more immersive resources comprise an image, one or more three-dimensional models, a video, an animated three-dimensional object, or any combination thereof.

13. The XR system of claim 9, wherein the immersive content comprises an image or video projected onto a three-dimensional shape.

14. The XR system of claim 9, wherein the executing XR application comprises a web browser, and the API call is triggered by a webpage loaded at the web browser.

15. The XR system of claim 9, wherein the executing XR application comprises an audio or video player that is playing media content, and the API call is triggered based on a timestamp of the playing media content.

16. The XR system of claim 9, wherein the instructions, when executed by the one or more processors, further cause the XR system to:
validate, prior to displaying the immersive content, the one or more immersive resources indicated by the API call.

17. A computer-readable storage medium storing instructions for native artificial reality (XR) system execution of an XR application using synthetic input from an external device, the instructions, when executed by the XR system, cause the XR system to:
execute an XR application, wherein the XR application assigned limited permissions to provide non-immersive content for a virtual object;
receive, from the executing XR application, an application programming interface (API) call that comprises one or more indicators for one or more immersive resources;
load, in response to the API call, the one or more immersive resources; and
display, by a system shell of the XR system and in response to the loading: a) non-immersive content, within the virtual object, provided by the XR application, and b) immersive content using the one or more loaded immersive resources.

18. The computer-readable storage medium of claim 17, wherein,
the limited permissions of the executing XR application permit control of the non-immersive content displayed via the virtual object and do not permit control of the immersive content for display via the XR system, and
an API exposed by software at the XR system supports display of the immersive content via the API call from the XR application.

19. The computer-readable storage medium of claim 17, wherein,
the virtual object comprises a two-dimensional virtual object and the non-immersive content comprises two-dimensional content,
the immersive content comprises an immersive XR environment, and
the virtual object and non-immersive content are displayed within the immersive XR environment.

20. The computer-readable storage medium of claim 17, wherein the executing XR application comprises a web browser, and the API call is triggered by a webpage loaded at the web browser.
